(19) United States
(12) Patent Application Publication
(10) Pub. No.: US 2012/0047537 A1
(43) Pub. Date: Feb. 23, 2012

(54) HIGH DEFINITION DIGITAL CCTV SYSTEM

(75) Inventor: Kyung Kook Lee, Seoul (KR)

(73) Assignee: TVLOGIC CO., LTD., Seoul (KR)

(21) Appl. No.: 13/146,413

(22) PCT Filed: Feb. 11, 2011
(86) PCT No.: PCT/KR11/00936

§ 371 Date: Jul. 27, 2011

(30) Foreign Application Priority Data
Feb. 23, 2010 (KR) 20-2010-0001915

(51) Int. Cl. H04N 7/18

(52) U.S. Cl. 725/78

(57) ABSTRACT

A high definition digital CCTV system is disclosed. In accordance with the present invention, a video signal combiner is connected to one or more video generating means and a video storage means in series or in parallel through a single cable to simplify a connection therebetween.

### TECHNICAL FIELD

The present invention relates to a high definition digital CCTV system, and particularly to a high definition digital CCTV system wherein a video signal combiner is connected to one or more video generating means and a video storage means in series or in parallel through a single cable to simplify a connection therebetween.

### BACKGROUND ART

Generally, a CCTV (Closed-Circuit TeleVision) system provides a video generated by capturing an object to a specific user. The high definition digital CCTV system is installed in a residence, a department store, a bank, a factory and an exhibition hall to be used as a monitoring system for preventing theft and inspecting state and operation of machinery.

The CCTV system may comprise one or more cameras for capturing the target for monitoring, a storage device for storing a video captured by the one or more cameras, i.e., a VCR (Video Cassette Recorder) or a digital storage device, and a monitor for outputting the video stored in the storage device.

The one or more cameras may be one of a regular camera, a dome-type camera, a zoom camera and an infrared camera. The video captured by the one or more cameras may be stored in the storage device, and the video stored in the storage device may be displayed through the monitor.

Since latest cameras provides an improved image quality, the one or more cameras is capable of capturing in more detailed.

A conventional CCTV system may transmit compressed video or uncompressed video captured by the one or more cameras.

In case of the uncompressed video, the video captured by the one or more cameras is converted to a HD-SDI (High Definition Serial Data Interface) signal without compression and then transmitted to the storage device. The storage device compresses and stores the HD-SDI signal. However, in this case, each of the one or more cameras should be connected to the storage device through a high performance cable. In addition, when a distance between each of the one or more cameras and the storage device is more than about 150 meters, a repeater, i.e., a relay equipment should be installed between each of the one or more cameras and the storage device in order to prevent a signal degradation.

In another case of the compressed video, the video captured by the one or more cameras is compressed using a codec such as H.264/AVC, and then transmitted to the storage device through an IP network. The storage device receives and stores the compressed video. However, in this case, the number of the one or more cameras that can be installed is limited by a maximum transfer capacity of the network because the video is transmitted via the network. In addition, a maximum transmission distance of the network is only about 300 meters, and a hub is required in order to transmit the video signal for more than 300 meters.

### DISCLOSURE

### Technical Problem

It is an object of the present invention to provide a high definition digital CCTV system wherein a video signal combiner is connected to one or more video generating means and a video storage means in series or in parallel through a single cable to simplify a connection therebetween.

### Technical Solution

In order to achieve above-described object of the present invention, there is provided a high definition digital CCTV system, comprising: a first video generating means through an n^{th} video generating means for generating a first video signal through an n^{th} video signal, respectively, wherein the first video signal through the n^{th} video signal are in a first frequency band through an n^{th} frequency band, respectively; a video storage means for storing a first video through an n^{th} video extracted from the first video signal through the n^{th} video signal, respectively; and a video output means for displaying the first video through the n^{th} video stored in the video storage means, and further comprising a video signal combiner for combining the first video signal through the n^{th} video signal and transmitting the first video signal through the n^{th} video signal combined thereby to the video output means, wherein the first video generating means through the n^{th} video generating means are connected to the video signal combiner in parallel, where n is a natural number.

Preferably, the m^{th} video generating means, the m^{th} video generating means being one of the first video generating means through the n^{th} video generating means, comprises: a video generator for generating the m^{th} video by capturing an object; a video digitizer for digitizing the m^{th} video captured by the video generator; a video compressor for compressing the m^{th} video digitized by the video digitizer; a video modulator for modulating the m^{th} video to an m^{th} transport stream signal, the m^{th} transport stream signal being in an intermediate frequency band; a channel allocating unit for allocating a channel ID to the m^{th} transport stream signal in the intermediate frequency band; and a frequency converter for upconverting the m^{th} transport stream signal in the intermediate frequency band into the m^{th} video signal in an m^{th} frequency band according to the channel ID, where 1=m<n, and m is a natural number.

Preferably, the m^{th} video generating means further comprises an amplifier for amplifying and transmitting the m^{th} video signal generated by the frequency converter to the video signal combiner.

Preferably, the video storage means comprises: a first video demodulator through an n^{th} demodulator for demodulating the first transport stream signal through the n^{th} transport stream signal, respectively, from the first video signal through the n^{th} video signal received from the video signal combiner; a first video extractor through an n^{th} video extractor for extracting the first video through the n^{th} video, respectively, from the first transport stream signal through the n^{th} transport stream signal demodulated by the first video demodulator through the n^{th} video demodulator; a first temporary storage through an n^{th} temporary storage for storing the first video through the n^{th} video extracted by the first video extractor through the n^{th} video extractor, respectively; a first video filter through an n^{th} video filter for filtering out a noise from the first video through the n^{th} video, respectively; and a video storage for storing the first video through the n^{th} video having the noises filtered out.

Preferably, the video output means comprises one or more monitors for displaying the first video through the n^{th} video stored in the video storage.

Preferably, the video signal combiner is connected to the video storage means through a single cable.

There is also provided a high definition digital CCTV system, comprising: a first video generating means through an n^{th} video generating means for generating a first video signal through an n^{th} video signal, respectively, wherein the first video signal through the n^{th} video signal are in a first frequency band through an n^{th} frequency band, respectively; a video storage means for storing a first video through an n^{th} video extracted from the first video signal through the n^{th} video signal, respectively; and a video output means for displaying the first video through the n^{th} video stored in the video storage means, and wherein the first video generating means through the n^{th} video generating means are connected to the video storage means in series, the m^{th} video generating means, the m^{th} video generating means being one of the first video generating means through the n^{th} video generating means, combines and transmits a video signal transmitted from the (m−1)^{th} video generating means and the m^{th} video signal to the (m+1)^{th} video generating means, and the n^{th} video generating means combines and transmits a video signal transmitted from the (n−1)^{th} video generating means and the n^{th} video signal to the video storage means, where 1=m<n, and m and n are natural numbers, respectively.

Preferably, the m^{th} video generating means comprises: a video generator for generating the m^{th} video by capturing an object; a video digitizer for digitizing the m^{th} video captured by the video generator; a video compressor for compressing the m^{th} video digitized by the video digitizer; a video modulator for modulating the m^{th} video to an m^{th} transport stream signal, the m^{th} transport stream signal being in an intermediate frequency band; a channel allocating unit for allocating a channel ID to the m^{th} transport stream signal in the intermediate frequency band; and a frequency converter for upconverting the m^{th} transport stream signal in the intermediate frequency band into the m^{th} video signal in an m^{th} frequency band according to the channel ID.

Preferably, the video storage means comprises: a first video demodulator through an n^{th} video demodulator for demodulating the first transport stream signal through the n^{th} transport stream signal, respectively, from the first video signal through the n^{th} video signal received from the video signal combiner; a first video extractor through an n^{th} video extractor for extracting the first video through the n^{th} video, respectively, from the first transport stream signal through the n^{th} transport stream signal demodulated by the first video demodulator through the n^{th} video demodulator; a first temporary storage through an n^{th} temporary storage for storing the first video through the n^{th} video extracted by the first video extractor through the n^{th} video extractor, respectively; a first video filter through an n^{th} video filter for filtering out a noise from the first video through the n^{th} video, respectively; and a video storage for storing the first video through the n^{th} video having the noises filtered out.

There is also provided a high definition digital CCTV system, comprising: a first video generating means through an n^{th} video generating means for generating a first video signal through an n^{th} video signal, respectively, wherein the first video signal through the n^{th} video signal are in a first frequency band through an n^{th} frequency band, respectively; a video storage means for extracting and storing a first video through an n^{th} video extracted from the first video signal through the n^{th} video signal, respectively, generated by the first video generating means through the n^{th} video generating means; and a video output means for displaying the first video through the n^{th} video stored in the video storage means, and wherein the m^{th} video generating means, the m^{th} video generating means being one of the first video generating means through the n^{th} video generating means, comprises: a video generator for generating the m^{th} video by capturing an object; a video digitizer for digitizing the m^{th} video captured by the video generator; a video compressor for compressing the m^{th} video digitized by the video digitizer; a video modulator for modulating the m^{th} video to an m^{th} transport stream signal, the m^{th} transport stream signal being in an intermediate frequency band; a channel allocating unit for allocating a channel ID to the m^{th} transport stream signal in the intermediate frequency band; and a frequency converter for upconverting the m^{th} transport stream signal in the intermediate frequency band into the m^{th} video signal in an m^{th} frequency band according to the channel ID, and an amplifier for amplifying and transmitting the m^{th} video signal generated by the frequency converter to the video signal combiner, and wherein the first video generating means through the n^{th} video generating means are connected to the video storage means in parallel, where 1=m<n, and m and n are natural numbers, respectively.

Preferably, the video storage means comprises: a first video demodulator through an n^{th} demodulator for demodulating the first transport stream signal through the n^{th} transport stream signal, respectively, from the first video signal through the n^{th} video signal received from the video signal combiner; a first video extractor through an n^{th} video extractor for extracting the first video through the n^{th} video, respectively, from the first transport stream signal through the n^{th} transport stream signal demodulated by the first video demodulator through the n^{th} video demodulator; a first temporary storage through an n^{th} temporary storage for storing the first video through the n^{th} video extracted by the first video extractor through the n^{th} video extractor, respectively; a first video filter through an n^{th} video filter for filtering out a noise from the first video through the n^{th} video, respectively; and a video storage for storing the first video through the n^{th} video having the noises filtered out.

Preferably, the video output means comprises one or more monitors for displaying the first video through the n^{th} video stored in the video storage.

### Advantageous Effects

In accordance with the present invention, a cost required for setting up the high definition digital CCTV system in accordance with the present invention is reduced by using a conventional coaxial cable.

Moreover, the high definition digital CCTV system in accordance with the present invention may simplify a single cable by connecting a video signal combiner connected to one or more video generating means and a video storage means through the single cable in series or in parallel.

### DESCRIPTION OF DRAWINGS

FIG. 1 is a block diagram illustrating a high definition digital CCTV system in accordance with a first embodiment of the present invention.

FIG. 2 is a block diagram illustrating a high definition digital CCTV system in accordance with a second embodiment of the present invention.

FIG. 3 is a block diagram illustrating a high definition digital CCTV system in accordance with a third embodiment of the present invention.

### BEST MODE

A high definition digital CCTV system in accordance with the present invention will now be described in detail with reference to the accompanied drawings.

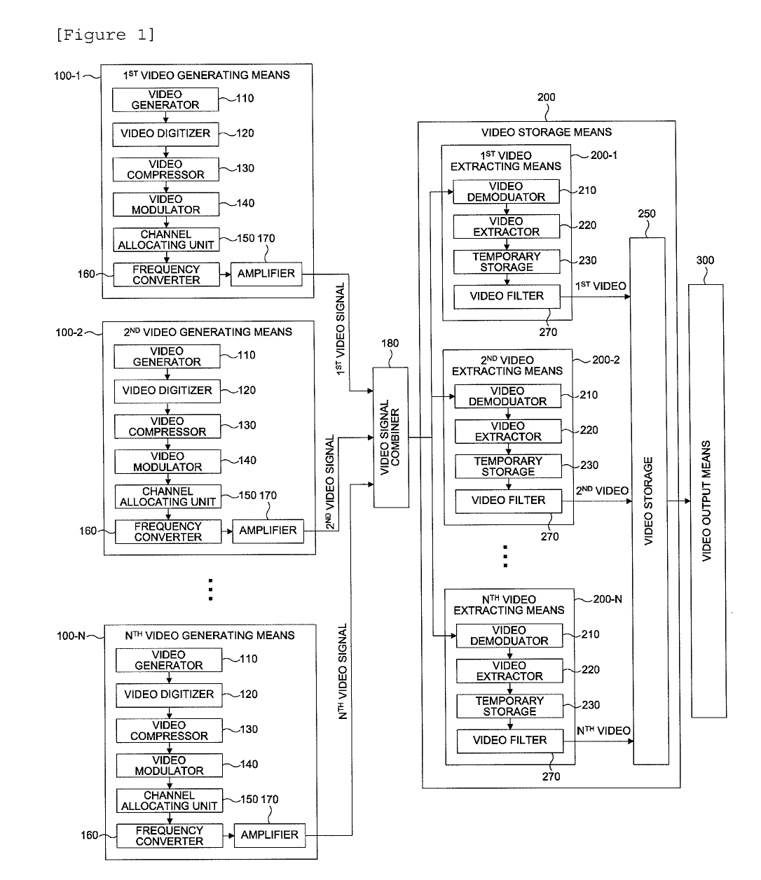

FIG. 1 is a block diagram illustrating a high definition digital CCTV system in accordance with a first embodiment of the present invention.

Referring to FIG. 1, the high definition digital CCTV (Closed-Circuit TeleVision) system in accordance with the first embodiment of the present invention comprises a first video generating means 100-1 through an n^{th} video generating means 100-n, a video storage means 200 and a video output means 300. In addition, the high definition digital CCTV system in accordance with the first embodiment of the present invention further comprises a video signal combiner 180, where n is a natural number.

Preferably, in accordance with the high definition digital CCTV system of the first embodiment of the present invention, a first video signal through an n^{th} video signal respectively generated by the first video generating means 100-1 through the n^{th} video generating means 100-n, which are connected to the video signal combiner 180 in parallel, are combined by the video signal combiner 180 and transmitted to the video storage means 200. A detailed description is given below with reference to FIG. 1.

The first video generating means 100-1 through the n^{th} video generating means 100-n generate the first video signal through the n^{th} video signal, respectively, which are in a first frequency band through an n^{th} frequency band, respectively.

Each of the first video generating means 100-1 through the n^{th} video generating means 100-n comprises a video generator 110, a video digitizer 120, a video compressor 130, a video modulator 140, a channel allocating unit 150 and a frequency converter 160. In addition, each of the first video generating means 100-1 through the n^{th} video generating means 100-n may further comprise an amplifier 170.

The first video generating means 100-1 through the n^{th} video generating means 100-n have substantially identical constitutions. Therefore, a detailed description of the first video generating means 100-1 will be given and description of the second video generating means 100-2 through the n^{th} video generating means 100-n will be focus on difference between the first video generating means 100-1 and the second video generating means 100-2 through the n^{th} video generating means 100-n.

The video generator 110 of the first video generating means 100-1 generates a video by capturing an object. Preferably, the video generator 110 may be embodied by a CCD (Charge Coupled Device) camera or a CMOS (Complementary Metal Oxide Semiconductor) camera capable of capturing the object in high definition.

The video digitizer 120 of the first video generating means 100-1 digitizes the video generated by the video generator 110. Preferably, the video digitizer 120 may comprise an A/D converter for digitizing an analog signal such as the video.

The video compressor 130 of the first video generating means 100-1 compresses the video digitized by the video digitizer 120. Preferably, the video compressor 130 may support MPEG4 (Motion Picture Experts Group 4) and MPEG2. The video compressed by the video compressor 130 is transmitted to the video modulator 140.

The video modulator 140 of the first video generating means 100-1 modulates the video compressed by the video compressor 130 to a transport stream signal. The transport stream signal is in an intermediate frequency band. Preferably, the video modulator 140 may modulate the video into the transport stream signal in the intermediate frequency band according to 8VSB (Vestigial Sideband) modulation or OFDM (Orthogonal Frequency division Multiplexing) modulation.

The channel allocating unit 150 of the first video generating means 100-1 allocates a channel ID to the transport stream signal modulated by the video modulator 140. The frequency converter 160 of the first video generating means 100-1 upconverts the transport stream signal in the intermediate frequency band into the video signal in a pre-determined frequency band. Preferably, the frequency converters 160 of the first video generating means 100-1 through the n^{th} video generating means 100-n upconvert the transport stream signal in the intermediate frequency band into the video signals in different frequency bands. The video signal outputted by the frequency converter 160 is transmitted to the amplifier 170.

The amplifier 170 of the first video generating means 100-1 amplifies the video signal received from the frequency converter 160 to output the first video signal. The first video signal outputted from the amplifier 170 is inputted into the video signal combiner 180.

Similarly, each of the second video generating means 100-2 through the n^{th} video generating means 100-n inputs the second video signal through the n^{th} video signal respectively generated by the second video generating means 100-2 through the n^{th} video generating means 100-n to the video signal combiner 180. However, each of the first video signal through the n^{th} video signal has different channel IDs, and upconverts the video signals in different frequency bands according to the different channel IDs.

The video signal combiner 180 combines the first video signal through the n^{th} video signal respectively inputted from the first video generating means 100-1 through the n^{th} video generating means 100-n. Preferably, the first video generating means 100-1 through the n^{th} video generating means 100-n may be connected to the video signal combiner 180 in parallel. The video signal combiner 180 transmits the combined video signals to the video storage means 200.

The video signal combiner 180 may be connected to the video storage means 200 through a single cable. The single cable may comprise one of a coaxial cable, an optical cable and an UTP (Unshielded Twisted Pair) cable.

The video storage means 200 stores the first video through the n^{th} video extracted from the first video signal through the n^{th} video signal generated by the first video generating means 100-1 through the n^{th} video generating means 100-n.

The video storage means 200 comprises a first video extractor means 200-1 through the n^{th} video extractor means 200-n and a video storage 250.

The first video extractor means 200-1 through the n^{th} video extractor means 200-n respectively extract the first video through the n^{th} video from the combined video signals received from the video signal combiner 180.

Each of the first video extractor means 200-1 through the n^{th} video extractor means 200-n comprises a video demodulator 210, a video extractor 220, a temporary storage 230 and a video filter 240.

The first video extractor means 200-1 through the n^{th} video extractor means 200-n have substantially identical constitutions. Therefore, a detailed description of the first video extractor means 200-1 will be given and descriptions of the second video extractor means 200-2 through the n^{th} video extractor means 200-n will be focused on difference between the first video extractor means 200-1 and the second video extractor means 200-2 through the n^{th} video extractor means 200-n.

The video demodulator 210 of the first video extractor means 200-1 demodulates the first transport stream signal from the combined video signals received from the video signal combiner 180. The first transport stream signal demodulated by the video demodulator 210 is transmitted to the video extractor 220.

The video extractor 220 of the first video extractor means 200-1 extracts the first video from the first transport stream signal demodulated by the video demodulator 210. The first video extracted by the video extractor 220 is transmitted to the temporary storage 230.

The temporary storage 230 of the first video extractor means 200-1 stores the first video extracted by the video extractor 220.

The video filter 240 of the first video extractor means 200-1 filters out noise from the first video. The first video having the noise filtered out is transmitted to the video storage 250.

Similarly, each of the second video extractor means 200-2 through the n^{th} video extractor means 200-n extracts the second video through the n^{th} video from the combined video signals received from the video signal combiner 180. The second video through the n^{th} video respectively extracted by the second video extractor means 200-2 through the n^{th} video extractor means 200-n are transmitted to the video storage 250.

The video storage 250 stores the first video through the n^{th} video respectively received from the first video extractor means 200-1 through the n^{th} video extractor means 200-n.

The video output means 300 outputs the first video through an n^{th} video stored in the video storage 250. Preferably, the video output means 300 may receive, from the video storage 250, and output the first video through an n^{th} video according to a control signal of a user. More preferably, the video output means 300 may comprise one or more monitors. The first video through an n^{th} video are outputted through one of the one or more monitors according to the control signal of the user.

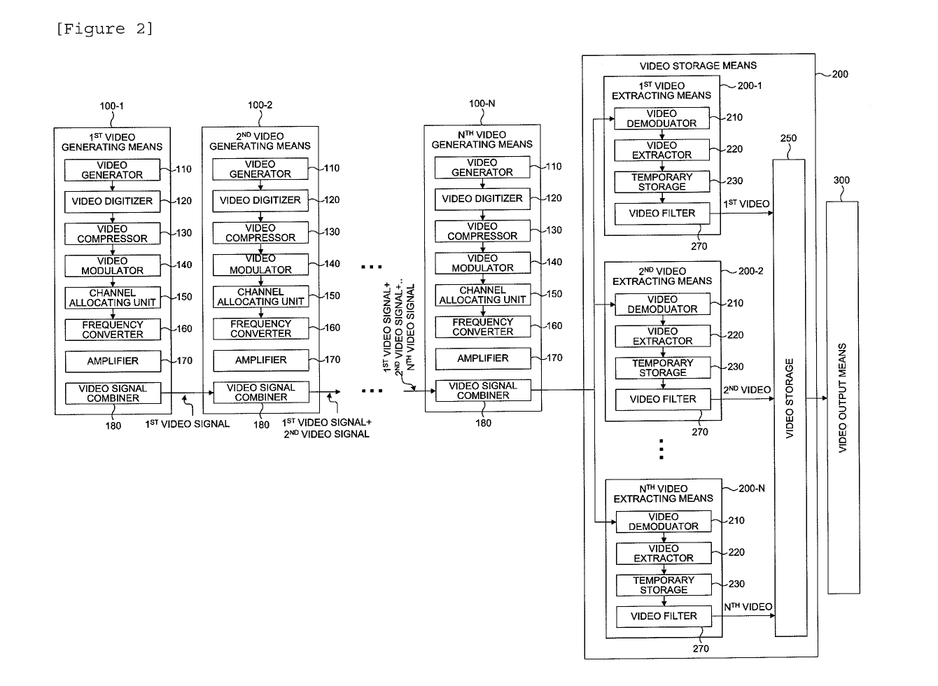

FIG. 2 is a block diagram illustrating a high definition digital CCTV system in accordance with a second embodiment of the present invention.

Referring to FIG. 2, the high definition digital CCTV system in accordance with the second embodiment of the present invention comprises a first video generating means 100-1 through an n^{th} video generating means 100-n, a video storage means 200 and a video output means 300, where n is a natural number.

Preferably, in accordance with the high definition digital CCTV system of the second embodiment of the present invention, the first video generating means 100-1 through the n^{th} video generating means 100-n are connected to the video storage means 200 in series, and a video signal combiner 180 is included in each of the first video generating means 100-1 through the n^{th} video generating means 100-n. That is, the high definition digital CCTV system in accordance with the second embodiment of the present invention differs from that of the first embodiment of the present invention in the first video generating means 100-1 through the n^{th} video generating means 100-n and the video signal combiner 180, and the video storage means 200 and the video output means 300 are identical. A detailed description is given below with reference to FIG. 2.

The first video generating means 100-1 through the n^{th} video generating means 100-n generate the first video signal through the n^{th} video signal, respectively, which are in a first frequency band through an n^{th} frequency band, respectively.

Each of the first video generating means 100-1 through the n^{th} video generating means 100-n comprises a video generator 110, a video digitizer 120, a video compressor 130, a video modulator 140, a channel allocating unit 150, a frequency converter 160 and the video signal combiner 180. In addition, each of the first video generating means 100-1 through the n^{th} video generating means 100-n may further comprise an amplifier 170.

The first video generating means 100-1 through the n^{th} video generating means 100-n have substantially identical constitutions. Therefore, a detailed description of the first video generating means 100-1 will be given and description of the second video generating means 100-2 through the n^{th} video generating means 100-n will be focus on difference between the first video generating means 100-1 and the second video generating means 100-2 through the n^{th} video generating means 100-n.

The video generator 110 of the first video generating means 100-1 generates a video by capturing an object. Preferably, the video generator 110 may be embodied by a CCD camera or a CMOS camera capable of capturing the object in high definition.

The video digitizer 120 of the first video generating means 100-1 digitizes the video generated by the video generator 110. Preferably, the video digitizer 120 may comprise an A/D converter for digitizing an analog signal such as the video.

The video compressor 130 of the first video generating means 100-1 compresses the video digitized by the video digitizer 120. Preferably, the video compressor 130 may support MPEG4 (Motion Picture Experts Group 4) and MPEG2. The video compressed by the video compressor 130 is transmitted to the video modulator 140.

The video modulator 140 of the first video generating means 100-1 modulates the video compressed by the video compressor 130 to a transport stream signal. The transport stream signal is in an intermediate frequency band. Preferably, the video modulator 140 may modulate the video into the transport stream signal in the intermediate frequency band according to 8VSB (Vestigial Sideband) modulation or OFDM (Orthogonal Frequency division Multiplexing) modulation.

The channel allocating unit 150 of the first video generating means 100-1 allocates a channel ID to the transport stream signal modulated by the video modulator 140. The frequency converter 160 of the first video generating means 100-1 upconverts the transport stream signal in the intermediate frequency band into the video signal in a pre-determined frequency band. Preferably, the frequency converters 160 of the first video generating means 100-1 through the n^{th} video generating means 100-n upconvert the transport stream signal in the intermediate frequency band into the video signals in different frequency bands. The video signal outputted by the frequency converter 160 is transmitted to the amplifier 170.

The amplifier 170 of the first video generating means 100-1 amplifies the video signal received from the frequency converter 160 to output the first video signal. The first video signal outputted from the amplifier 170 is inputted into the video signal combiner 180.

The video signal combiner 180 of the first video generating means 100-1 inputs the first video signal outputted from the amplifier 170 to the video signal combiner 180 of the second video generating means 100-2.

Similarly, the video signal combiner 180 of the second video generating means 100-2 combines the second video signal outputted from the amplifier 170 of the second video generating means 100-2 with the first video signal received from the video signal combiner 180 of the first video generating means 100-1, and inputs the combined video signal to the video signal combiner 180 of the third video generating means 100-3.

That is, the video signal combiner 180 of the m^{th} video generating means 100-m combines the m^{th} video signal outputted from the amplifier 170 of the m^{th} video generating means 100-m with the video signal received from the video signal combiner 180 of the (m⁻¹)^{th} video generating means 100-(m−1) and inputs the combined video signal to the video signal combiner 180 of the (m+1)^{th} video generating means 100-(m+1), where 1=m<n, and m and n are natural numbers.

Preferably, the video signal combiner 180 of the n^{th} video generating means 100-n combines the n^{th} video signal outputted from the amplifier 170 of the n^{th} video generating means 100-n with the video signal received from the video signal combiner 180 of the (n−1)^{th} video generating means 100-(n−1) and inputs the combined video signal to the video storage means 200.

The video signal combiner 180 may be connected to the video storage means 200 through a single cable. The single cable may comprise one of a coaxial cable, an optical cable and an UTP (Unshielded Twisted Pair) cable.

The video storage means 200 stores the first video through the n^{th} video extracted from the first video signal through the n^{th} video signal generated by the first video generating means 100-1 through the n^{th} video generating means 100-n and the video output means 300 outputs the first video through an n^{th} video stored in the video storage 250.

Preferably, constitutions of the video storage means 200 and the video output means 300 in accordance with the second embodiment of the present invention are substantially identical to those of the first embodiment of the present invention. Therefore, detailed descriptions of the video storage means 200 and the video output means 300 are omitted.

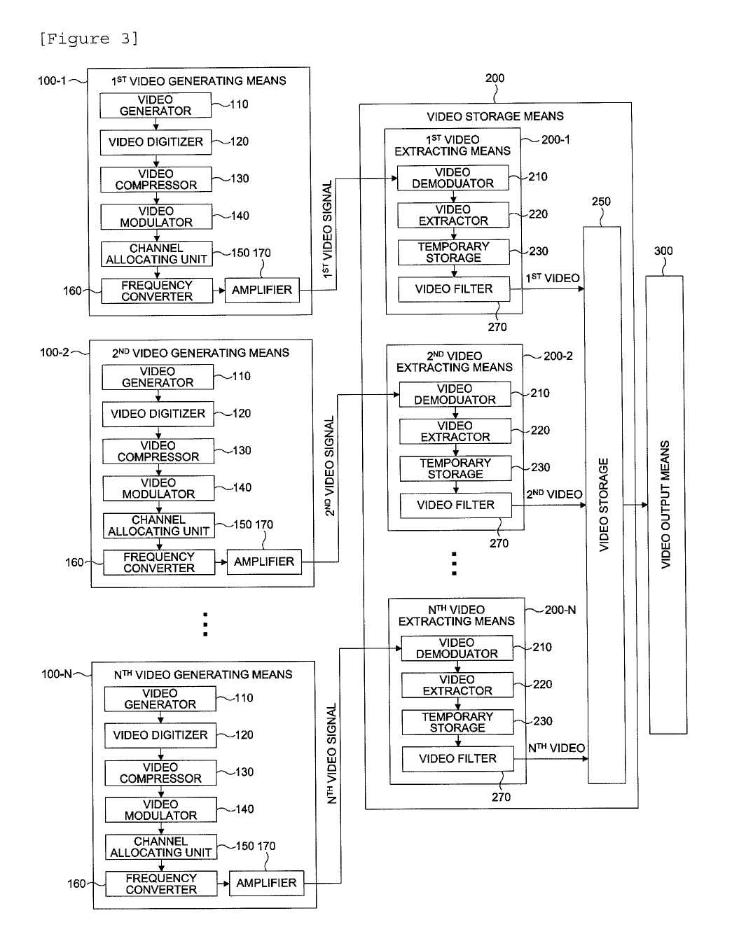

FIG. 3 is a block diagram illustrating a high definition digital CCTV system in accordance with a third embodiment of the present invention.

Referring to FIG. 3, the high definition digital CCTV system in accordance with the third embodiment of the present invention comprises a first video generating means 100-1 through an n^{th} video generating means 100-n, a video storage means 200 and a video output means 300.

Preferably, in accordance with the high definition digital CCTV system of the second embodiment of the present invention, the first video generating means 100-1 through the n^{th} video generating means 100-n are connected to the video storage means 200 in parallel. In addition, the first video generating means 100-1 through the n^{th} video generating means 100-n does not comprise a video signal combiner 180. That is, the high definition digital CCTV system in accordance with the third embodiment of the present invention differs from that of the first embodiment of the present invention in the first video generating means 100-1 through the n^{th} video generating means 100-n and the video signal combiner 180, and the video storage means 200 and the video output means 300 are identical. A detailed description is given below with reference to FIG. 3.

The first video generating means 100-1 through the n^{th} video generating means 100-n generate the first video signal through the n^{th} video signal, respectively, which are in a first frequency band through an n^{th} frequency band, respectively.

Each of the first video generating means 100-1 through the n^{th} video generating means 100-n comprise a video generator 110, a video digitizer 120, a video compressor 130, a video modulator 140, a channel allocating unit 150 and a frequency converter 160. In addition, each of the first video generating means 100-1 through the n^{th} video generating means 100-n may further comprise an amplifier 170.

The first video generating means 100-1 through the n^{th} video generating means 100-n have substantially identical constitutions. Therefore, a detailed description of the first video generating means 100-1 will be given and description of the second video generating means 100-2 through the n^{th} video generating means 100-n will be focus on difference between the first video generating means 100-1 and the second video generating means 100-2 through the n^{th} video generating means 100-n.

The video generator 110 of the first video generating means 100-1 generates a video by capturing an object. Preferably, the video generator 110 may be embodied by a CCD (Charge Coupled Device) camera or a CMOS (Complementary Metal Oxide Semiconductor) camera capable of capturing the object in high definition.

The video digitizer 120 of the first video generating means 100-1 digitizes the video generated by the video generator 110. Preferably, the video digitizer 120 may comprise an A/D converter for digitizing an analog signal such as the video.

The video compressor 130 of the first video generating means 100-1 compresses the video digitized by the video digitizer 120. Preferably, the video compressor 130 may support MPEG4 (Motion Picture Experts Group 4) and MPEG2. The video compressed by the video compressor 130 is transmitted to the video modulator 140.

The video modulator 140 of the first video generating means 100-1 modulates the video compressed by the video compressor 130 to a transport stream signal. The transport stream signal is in an intermediate frequency band. Preferably, the video modulator 140 may modulate the video into the transport stream signal in the intermediate frequency band according to 8VSB (Vestigial Sideband) modulation or OFDM (Orthogonal Frequency division Multiplexing) modulation.

The channel allocating unit 150 of the first video generating means 100-1 allocates a channel ID to the transport stream signal modulated by the video modulator 140. The frequency converter 160 of the first video generating means 100-1 upconverts the transport stream signal in the intermediate frequency band into the video signal in a pre-determined frequency band. Preferably, the frequency converters 160 of the first video generating means 100-1 through the n^{th} video generating means 100-n upconvert the transport stream signal in the intermediate frequency band into the video signals in different frequency bands. The video signal outputted by the frequency converter 160 is transmitted to the amplifier 170.

The amplifier 170 of the first video generating means 100-1 amplifies the video signal received from the frequency converter 160 to output the first video signal. The first video signal outputted from the amplifier 170 is inputted into the video storage means 200. Preferably, the amplifier 170 of the first video generating means 100-1 inputs the first video signal to a first video extractor means 200-1 included in the video storage means 200.

Similarly, the second video generating means 100-2 through the n^{th} video generating means 100-n respectively input the second video signal through the n^{th} video signal respectively generated by the second video generating means 100-2 through the n^{th} video generating means 100-n into the video storage means 200, i.e., a second video extractor means 200-2 through a n^{th} video extractor means 200-n. However, each of the first video signal through the n^{th} video signal has different channel IDs, and are upconverted to the video signals in different frequency bands according to the different channel IDs.

The video storage means 200 stores the first video through the n^{th} video extracted from the first video signal through the n^{th} video signal generated by the first video generating means 100-1 through the n^{th} video generating means 100-n and the video output means 300 outputs the first video through an n^{th} video stored in the video storage 250.

Preferably, constitutions of the video storage means 200 and the video output means 300 in accordance with the third embodiment of the present invention has substantially identical constitutions thereof in accordance with the first embodiment of the present invention. Therefore, detailed descriptions of the video storage means 200 and the video output means 300 are omitted.

While the present invention has been particularly shown and described with reference to the preferred embodiment thereof, it will be understood by those skilled in the art that various changes in form and details may be effected therein without departing from the spirit and scope of the invention as defined by the appended claims.

1. A high definition digital CCTV system, comprising:
a first video generating means through an n^{th} video generating means for generating a first video signal through an n^{th} video signal, respectively, wherein the first video signal through the n^{th} video signal are in a first frequency band through an n^{th} frequency band, respectively;
a video storage means for storing a first video through an n^{th} video extracted from the first video signal through the n^{th} video signal, respectively; and
a video output means for displaying the first video through the n^{th} video stored in the video storage means, and further comprising a video signal combiner for combining the first video signal through the n^{th} video signal and transmitting the first video signal through the n^{th} video signal combined thereby to the video output means, wherein the first video generating means through the n^{th} video generating means are connected to the video signal combiner in parallel, where n is a natural number.

2. The system in accordance with claim 1, wherein the m^{th} video generating means, the m^{th} video generating means being one of the first video generating means through the n^{th} video generating means, comprises:
a video generator for generating the m^{th} video by capturing an object;
a video digitizer for digitizing the m^{th} video captured by the video generator;
a video compressor for compressing the m^{th} video digitized by the video digitizer;
a video modulator for modulating the m^{th} video to an m^{th} transport stream signal, the m^{th} transport stream signal being in an intermediate frequency band;
a channel allocating unit for allocating a channel ID to the m^{th} transport stream signal in the intermediate frequency band; and
a frequency converter for upconverting the m^{th} transport stream signal in the intermediate frequency band into the m^{th} video signal in an m^{th} frequency band according to the channel ID, where 1=m<n, and m is a natural number.

3. The system in accordance with claim 2, wherein the m^{th} video generating means further comprises an amplifier for amplifying and transmitting the m^{th} video signal generated by the frequency converter to the video signal combiner.

4. The system in accordance with claim 3, wherein the video storage means comprises:
a first video demodulator through an n^{th} video demodulator for demodulating the first transport stream signal through the n^{th} transport stream signal, respectively, from the first video signal through the n^{th} video signal received from the video signal combiner;
a first video extractor through an n^{th} video extractor for extracting the first video through the n^{th} video, respectively, from the first transport stream signal through the n^{th} transport stream signal demodulated by the first video demodulator through the n^{th} video demodulator;
a first temporary storage through an n^{th} temporary storage for storing the first video through the n^{th} video
a first video filter through an n^{th} video filter for filtering out a noise from the first video through the n^{th} video, respectively; and
a video storage for storing the first video through the n^{th} video having the noises filtered out.

5. The system in accordance with claim 4, wherein the video output means comprises one or more monitors for displaying the first video through the n^{th} video stored in the video storage.

6. The system in accordance with claim 5, wherein the video signal combiner is connected to the video storage means through a single cable.

7. A high definition digital CCTV system, comprising:
a first video generating means through an n^{th} video generating means for generating a first video signal through an n^{th} video signal, respectively, wherein the first video signal through the n^{th} video signal are in a first frequency band through an n^{th} frequency band, respectively;
a video storage means for storing a first video through an n^{th} video extracted from the first video signal through the n^{th} video signal, respectively; and
a video output means for displaying the first video through the n^{th} video stored in the video storage means, and
wherein the first video generating means through the n^{th} video generating means are connected to the video storage means in series, the m^{th} video generating means, the m^{th} video generating means being one of the first video generating means through the n^{th} video generating means, combines and transmits a video signal transmitted from the (m−1)^{th} video generating means and the m^{th} video signal to the (m+1)^{th} video generating means, and the n^{th} video generating means combines and transmits a video signal transmitted from the (n−1)^{th} video generating means and the n^{th} video signal to the video storage means, where 1=m<n, and m and n are natural numbers, respectively.

8. The system in accordance with claim 7, wherein the m^{th} video generating means comprises:
a video generator for generating the m^{th} by capturing an object;
a video digitizer for digitizing the m^{th} video captured by the video generator;
a video compressor for compressing the m^{th} video digitized by the video digitizer;
a video modulator for modulating the m^{th} video to an m^{th} transport stream signal, the m^{th} transport stream signal being in an intermediate frequency band;
a channel allocating unit for allocating a channel ID to the m^{th} transport stream signal in the intermediate frequency band; and
a frequency converter for upconverting the m^{th} transport stream signal in the intermediate frequency band into the m^{th} video signal in an m^{th} frequency band according to the channel ID.

9. The system in accordance with claim 8, wherein the m^{th} video generating means further comprises an amplifier for amplifying and transmitting the m^{th} video signal generated by the frequency converter to the video signal combiner.

10. The system in accordance with claim 9, wherein the video storage means comprises:
a first video demodulator through an n^{th} video demodulator for demodulating the first transport stream signal through the n^{th} transport stream signal, respectively, from the first video signal through the n^{th} video signal received from the video signal combiner;
a first video extractor through an n^{th} video extractor for extracting the first video through the n^{th} video, respectively, from the first transport stream signal through the n^{th} transport stream signal demodulated by the first video demodulator through the n^{th} video demodulator;
a first temporary storage through an n^{th} temporary storage for storing the first video through the n^{th} video extracted by the first video extractor through the n^{th} video extractor, respectively;
a first video filter through an n^{th} video filter for filtering out a noise from the first video through the n^{th} video, respectively; and
a video storage for storing the first video through the n^{th} video having the noises filtered out.

11. The system in accordance with claim 10, wherein the video output means comprises one or more monitors for displaying the first video through the n^{th} video stored in the video storage.

12. The system in accordance with claim 11, wherein the n^{th} video generating means is connected to the video storage means through a single cable.

13. A high definition digital CCTV system, comprising:
a first video generating means through an n^{th} video generating means for generating a first video signal through an n^{th} video signal, respectively, wherein the first video signal through the n^{th} video signal are in a first frequency band through an n^{th} frequency band, respectively;
a video storage means for extracting and storing a first video through an n^{th} video extracted from the first video signal through the n^{th} video signal, respectively, generated by the first video generating means through the n^{th} video generating means; and
a video output means for displaying the first video through the n^{th} video stored in the video storage means, and m^{th} wherein the m^{th} video generating means, the m^{th} video generating means being one of the first video generating means through the n^{th} video generating means, comprises:
a video generator for generating the m^{th} video by capturing an object;
a video digitizer for digitizing the m^{th} video captured by the video generator;
a video compressor for compressing the m^{th} video digitized by the video digitizer;
a video modulator for modulating the m^{th} video to an m^{th} transport stream signal, the m^{th} transport stream signal being in an intermediate frequency band;
a channel allocating unit for allocating a channel ID to the m^{th} transport stream signal in the intermediate frequency band; and
a frequency converter for upconverting the m^{th} transport stream signal in the intermediate frequency band into the m^{th} video signal in an m^{th} frequency band according to the channel ID, and
an amplifier for amplifying and transmitting the m^{th} video signal generated by the frequency converter to the video signal combiner, and
wherein the first video generating means through the n^{th} video generating means are connected to the video storage means in parallel, where 1=m<n, and m and n are natural numbers, respectively.

14. The system in accordance with claim 13, wherein the video storage means comprises:
a first video demodulator through an n^{th} video demodulator for demodulating the first transport stream signal through the n^{th} transport stream signal, respectively, from the first video signal through the n^{th} video signal received from the video signal combiner;
a first video extractor through an n^{th} video extractor for extracting the first video through the n^{th} video, respectively, from the first transport stream signal through the n^{th} transport stream signal demodulated by the first video demodulator through the n^{th} video demodulator;
a first temporary storage through an n^{th} temporary storage for storing the first video through the n^{th} video extracted by the first video extractor through the n^{th} video extractor, respectively;
a first video filter through an n^{th} video filter for filtering out a noise from the first video through the n^{th} video, respectively; and
a video storage for storing the first video through the n^{th} video having the noises filtered out.

15. The system in accordance with claim 14, wherein the video output means comprises one or more monitors for displaying the first video through the n^{th} video stored in the video storage.
